(19) United States
(12) Patent Application Publication
(10) Pub. No.: US 2006/0277091 A1
(43) Pub. Date: Dec. 7, 2006

(54) Automated method for quantitative measurement of benefits in a plurality of self-assessing, knowledge sharing communities

(76) Inventors: Vivekanand Pai Kochikar, Bangalore (IN); Salmo Mahind Chandra Sen, Bangalore (IN); Kavi Mahesh, Bangalore (IN); Suresh Kapanipathy, Janivara (IN)

Correspondence Address: BRUZGA & ASSOCIATES, 11 BROADWAY, SUITE 715, NEW YORK, NY, 10004, US

(21) Appl. No.: 10/551,829

(22) PCT Filed: Mar. 12, 2004
(86) PCT No.: PCT/IB04/01164

§ 371 Date: Dec. 22, 2005

(30) Foreign Application Priority Data
Apr. 2, 2003 (IN) 277/MAS/2003

(51) Int. Cl. G05B 19/418

(52) U.S. Cl. 705/10; 705/8

(57) ABSTRACT

The invention describes method and a system to measure benefits associated with the sharing of knowledge in a plurality of hierarchical knowledge sharing communities. The 5 measurements are based on assessments provided by the members of the community and the usage of the assets and are an index of the benefits arising from the knowledge shared within, and the knowledge contributed to and derived from the members of, the community, at individual and collective levels. The invention also describes a hierarchical arrangement of the knowledge assets and the members in various knowledge 10 sharing communities as well as an incentivisation scheme for the members.

### FIELD OF THE INVENTION

The present invention pertains in general to knowledge management in collaborative knowledge sharing communities; more particularly, it refers to a measurement system for determining the benefits of knowledge sharing in such communities and providing incentives in return for the contribution made to the community.

### BACKGROUND OF THE INVENTION

As knowledge management has come to acquire a pervasive and ubiquitous function in business, academic, government, social and personal life, it has become increasingly important to be able to develop a system of measurement to quantify the benefits associated with the process of sharing knowledge through interactions between individuals who form part of communities structured either explicitly or implicitly for the purpose of sharing knowledge. Further, these benefit measures can act as an incentive to the members of the community and thereby enable increased effectiveness in the sharing of knowledge through implied and real benefits accrued at the individual and collective levels. In general, communities can be envisioned as being structured in a hierarchical form, comprising sub-communities with different and specific foci, and super-communities arising from a logical aggregation of different communities. Given such a structure, there is a corresponding need to be able to carry out benefit measurements to the sharing of knowledge within these hierarchical entities. Such a system of measurement would readily benefit knowledge management in any community where the members belong either to an organization such as a corporation, a university, a government department, a professional association, and so on, or in a community that is formed for the specific purpose of sharing knowledge in an area of interest. The meaning of a community would also encompass various special-interest groups, discussion forums, chat groups, and the like. While the invention in its generality covers all forms of knowledge sharing, it is most readily applicable where knowledge sharing happens through on-line mechanisms.

A knowledge sharing community generally, although not exclusively, comprises people with common areas of interest, common intents and purposes for sharing, and having a collectively accepted protocol for the form, structure and content of the knowledge that is shared between the members of the community, as well as the modes of interaction which would aid the process of sharing knowledge. The employees of an Information Technology (IT) company who use a computer network to share knowledge in the form of documents of different kinds, as for example related to, software technologies, software project management processes, people oriented human relations (HR) practices, etc would exemplify a knowledge sharing community. In this example, the usual connotations associated with a community—of its members being related through geography and kinship—can be understood in a broader way to include geographically distributed membership and kinship engendered by a common purpose related to the company's activities. The commonality of areas of interest could exist at different levels of abstraction without affecting the meaning of the word community, as in the example above, where a developer of software systems could primarily contribute to, and benefit from, the knowledge management system in the areas of technologies without necessarily having any relationship with other components of the system which may be directed towards project management or people related practices, etc. The protocols for sharing knowledge could be different for each community. For example, a community of ophthalmologists could share knowledge primarily through physical participation in periodic lectures, seminars, surgical or clinical demonstrations, and publication of newsletters; whereas a community of Java developers could share knowledge primarily through participation in virtual modes of interaction, viz., chat sessions, online reviews of publications, discussion forums, and collaborative evolution of standards, technologies and co-development of new idioms of programming, packages, products and proofs-of-concepts among its members.

Knowledge assets constitute a primary transactional medium for the knowledge shared between members of a community. Here, no limitations and constraints are implied in the form, structure or manifestation of the knowledge being shared except to the extent of common acceptability within, and systemic constraints applicable to, the community sharing knowledge. Thus, for instance, documents forming the basis of knowledge sharing could be either in physical or electronic forms; also, knowledge sharing itself could be carried out without documents of any kind, as in the case of brain storming sessions, workshops, off-line discussions between groups of people, one-to-one mentoring in face to face interactions, and the like. Knowledge assets therefore can in general be considered to be content of various kinds presented in different ways—as exemplified by documents, audio and video clips, publications, records of debates, discussions, workshops, interactive lectures, knowledge sharing sessions, white boarding and on-line collaboration sessions, telephonic conferences, video conferences, chat sessions, expertise profiles (which provides knowledge about knowledge, in this case, of expertise among members of a community), and so forth.

The measurement of the benefits of sharing knowledge is of significance in determining the functionality and health of the knowledge sharing community's practices, in addition to being an index of the maturity and value associated with the sum total knowledge resident in the community at a given point in time. The benefit measurements in turn would be a powerful means to elicit contributions from members on a continuous basis. In general, the benefits could cover those derived from, and provided to, hierarchical communities, each community itself and an individual who is a part of one or more communities. To be able to develop an objective system to quantitatively measure the benefits of knowledge sharing, a consideration of the entire life cycle of knowledge capture, structuring, sharing and use and so forth would be of fundamental importance. Capturing knowledge could be done in a variety of ways—through documents such as white papers, manuals, tools, operational procedures and processes, etc submitted by members, or created through interviews with facilitators, transcription of discussions, recording of knowledge sharing sessions in audio, video or some other electronic form, on-line records of chat sessions and discussion forums, etc. Matching its characteristics with those associated with a classification system appropriate to the particular knowledge sharing activity, in general, we can carry out the structuring of such captured knowledge. The actual process of sharing and use among the members of the community would then provide the basis for rating the different knowledge assets available within the community. This could be done with two measures, one through user assigned ratings, transmitted for recording to a system maintained by the community to track ratings, of a knowledge asset as may be related to its perceived quality, utility, relevance, applicability, and so on. The other would be through system calculated parameters related to the knowledge sharing transaction, such as, the number of times the asset has been used, recency and frequency of use, time of use, and the like, either in relation to the past use of the said asset in isolation or in relation to all, or some, of the other knowledge assets available for use with the community, as may be determined by the community. These parameters can be used to modulate the ratings assigned to the asset and the contributor of the knowledge asset per transaction, as well as points, if any, assigned to the user for the usage of the knowledge asset. It must be noted here that, in their generality, ratings given are based only on an assumption of a beneficiary-benefactor relationship in the act of sharing knowledge. These ratings of assets, in turn, could be used to order the assets themselves in specific logical/physical ways to cater to subsequent requests for assets of that particular type. For instance, the rating of a document could be used as the basis for retrieving a document with the highest rating on the topic requested for by a user. In addition, the rating obtained by the benefactor and beneficiary of the transactions could in turn be translatable to pre-defined rewards provided by the community. For purposes of setting policies and providing directions, such as may be related to the redemption of points accrued by members for rewards, the determination of time periods during which redemption is permitted and/or not permitted and so on, the community could designate, perhaps following a democratic process, certain members as moderators from time to time.

However, not all knowledge assets available to the community may be required to be rated. In general, the community would decide what knowledge assets are subject to rating, and by whom in the community. For instance, a knowledge asset such as an expertise profile may be treated by a community as not subject to rating; as for documents, the community may allow all users to rate a document, so long as it is first reviewed (a review may be considered here as a special type of user rating) and accepted for depositing it with the community for all members to use. Similarly, the community may have a policy for retirement of documents which may be related to the document's attributes—content, age, frequency and recency of use, utility, and the like.

Various methods and systems have been proposed at a generic level for knowledge management in a business organization. U.S. Pat. No. 5,924,072 for Knowledge Management System and Method to Charnell T. Havens, U.S. Pat. No. 6,182,067 for Methods and Systems for Knowledge Management to Presnell et al., WO 01/08096 for Knowledge Management System to Denise L. Holz, and WO 98/32083 for Knowledge Management System and Method to Anthony D. Sullivan all disclose knowledge management methods and systems that cover the core ideas of a repository of knowledge that is shared across an organization with methods for adding new knowledge items to the repository and for retrieving relevant items from it as well as methods to provide feedback on retrieved items and to collect usage data for knowledge items.

It must be noted that the term “knowledge management system” is also used to describe disclosures of information storage, retrieval and search systems such as in WO 97/21179 to Butler et al. The term is also used in disclosures of systems for managing knowledge bases for expert systems and artificial intelligence as in WO 99/66420 to Guignard et al. These two uses of the term are not directly relevant to the present disclosure.

Several disclosures in the prior art have proposed metrics to measure the value of a knowledge item in an organization. Some of these metrics are based on usage statistics for the particular knowledge item, including the frequency and recency of usage of the item by members of the organization (e.g., U.S. Pat. No. 5,924,072, U.S. Pat. No. 6,182,067 and U.S. Pat. No. 5,079,718). Similarly, metrics based on subjective evaluations of knowledge items by its users have been proposed in U.S. Pat. No. 5,924,072 and U.S. Pat. No. 6,182,067.

The idea of using ratings assigned by selected reviewers to measure the value of knowledge items has been disclosed in U.S. Pat. No. 5,706,452 to Ivanov and WO 01/08096 to Denise L. Holz. These metrics constitute another dimension of value that is useful in a knowledge management system.

A concept-based organization of knowledge assets together with a search and retrieval engine that provides a concept-match based technique to select knowledge items is ideally suited to knowledge management systems (as opposed to keyword matching systems). In addition, the ideal knowledge management system must also provide a plurality of hierarchies of concepts along which the user can navigate to browse the knowledge stored against the hierarchies. Such concept-based retrieval systems are disclosed for example in U.S. Pat. No. 6,182,067 and U.S. Pat. No. 6,327,593 to David A. Goiffon. Multi-dimensional hierarchies (also called taxonomies) and their use in organizing and retrieving knowledge items are disclosed in U.S. Pat. No. 6,327,593 to Goiffon, WO 01/08096 to Holz and WO 00/77690 to Kay et al.

It may be noted here that a simpler alternative to multi-dimensional hierarchies in the form of two-dimensional matrices, as disclosed in WO 97/21179 to Butler is not adequate for knowledge management purposes in a typical organization where the usage of a knowledge item cannot be predetermined and directly mapped to particular business processes or types of users.

Several disclosures propose the idea of retiring knowledge items if their value falls below a certain threshold to save storage space as well as to make it easier for users to find current items. For example U.S. Pat. No. 5,079,718 to Tanaka discloses a “cancel function” which is essentially a retirement mechanism (akin to a computer memory management algorithm) based entirely on usage statistics. U.S. Pat. No. 6,182,067 to Presnell discloses a retirement method based on usage statistics as well as subjective user evaluations.

A key issue in deploying a knowledge management system in an organization lies in providing incentives to its members to participate in effective knowledge management (such as to share their knowledge or to re-use knowledge shared by others). At a generic level, U.S. Pat. No. 5,924,072 to Havens discloses that subjective user evaluations and usage statistics can be used to provide incentives to authors of knowledge items.

A key problem in knowledge management is to measure progress in deploying a knowledge management solution in an organization. Another key problem is to measure benefits of using knowledge management. Both of these require metrics for determining the current ratings of not only knowledge items but also of members of the organization with reference to their contributions to knowledge management as well as ratings of entire groups or sub-communities in the organization. There is no clear and comprehensive set of metrics available in prior art to meet these requirements.

Further, the prior art disclosures do not provide a comprehensive metric that combines reviewer ratings with metrics derived from user evaluations and usage statistics. It is not clear from the prior art as to how the various metrics could be combined. In addition, selecting an appropriate reviewer for a new or revised knowledge item continues to be a problem with no clear method for systematic or automatic selection

A typical large knowledge sharing community needs to be organized into a hierarchy of sub-communities for effective management of knowledge in various areas of interest or focus. There is no method in the prior art that discloses a metric for measuring progress and benefits of knowledge management in such a hierarchy of communities.

### SUMMARY OF THE INVENTION

According to the present invention, the disadvantages and problems associated with prior art in knowledge management methods, systems, and programs have been substantially reduced or eliminated.

It is a primary objective of the present invention to disclose a comprehensive set of metrics for measuring the value that knowledge items, individual members, and entire communities and sub-communities provide to an organization through knowledge management.

It is another objective of the present invention to have a method of organizing a set of communities and sub-communities against a multi-dimensional knowledge hierarchy and thereby be able to calculate the said metrics for a community or sub-community at any level in the hierarchies.

It is a further objective of the present invention to disclose a method of selecting reviewers for a knowledge item by matching the knowledge paths in the knowledge hierarchies for the knowledge item with knowledge paths in the same hierarchies that denote the areas of expertise of recognized members of the community.

It is yet another objective of the present invention to disclose a method for calculating and providing a variety of incentives to members of the community including both milestone rewards and proportionate redemptions based on the said metrics.

The present invention provides a system to measure benefits associated with the sharing of knowledge in a plurality of hierarchical knowledge sharing communities. In such communities, various types of knowledge sharing interactions are envisaged at the formal, semi-formal or informal levels, the only condition being that corresponding knowledge assets be identified and provided in an electronic or other forms to further the activities of the community. A transaction based device and quantitative rating system to capture, classify, store, use, share, encourage, rate, rank, prioritize and retire some or all of the intellectual assets in a knowledge sharing community is disclosed. The rating system would measure benefits associated with the knowledge assets, beneficiaries and contributors in the community as well as the community itself. Further, the measurements are based on assessments provided by the members of the community resulting in an incremental, evolving metric of all aspects of knowledge sharing including the quality and potential utility of the knowledge assets owned by the community, expertise of members and the benefits derived by the community as well as its members.

The invention details methods for calculating these metrics at any point in time based on usage statistics, subjective user evaluations, as well as reviewer ratings. The metrics can be used to track progress and measure benefits of knowledge management.

For the purposes of the current invention, a member of a sub-community would be automatically considered a member of a community, but not vice-versa. For instance, in a community of programming language enthusiasts, there could be sub-communities for Java and C# pronounced C sharp) as languages. The member of the Java sub-community (or the C# community) would be considered a member of the programming language community, but not vice-versa. Conversely, one can be a member of a community without being a member of any sub-community. A member of one community would be free to become a member of any other community. When a member ends his/her association with a community, he/she is considered to be an ex-member; the active (and not retired) knowledge assets of the ex-member would continue to be rated by the members of the community, although any ratings ascribed to the ex-member as the creator of the knowledge assets would not accrue to the aggregate rating of the ex-member. The hierarchy of communities referred to in the present invention makes no assumption regarding the existence of a universal community.

A community whose members themselves measure the knowledge sharing between the members would constitute a self-assessing community. In such communities, a continual assessment of the knowledge sharing by all members would occur during the normal course of use. Thus, assessment through rating of the knowledge shared is an emergent property of such communities where there are likely to be no clear demarcation of roles such as leaders, assigned reviewers and so on. With the condition that a member can provide only one rating to a knowledge asset at a given time, continuous and incremental changes over time to the ratings of knowledge assets can result from new rating by members who have not rated the asset earlier, revision of old rating (due to changes in perceived value of an asset) by members, and so forth. Further, the rating metric, aggregated over different transactions at the member, sub-community and the community levels, would itself be a time-wise dynamic measure of benefits, an index of functionality and value, as well as an incentive for contribution and use.

For the purposes of this invention, a community per se would be understood as one that conducts its activities without explicit commercial terms (other than membership fees) for both contribution and usage of the knowledge contributed directly, or derived consequentially, from the activities of the members in whatever form as related to the community; further, capture of knowledge from members (at least partially), sharing of knowledge, and assessing the benefits of such sharing, by members are key requirements for such communities. It is, however, important to note that the definition above does not preclude individuals from using the community's shared knowledge in turn for commercial purposes so long as the activity of sharing knowledge within the community is carried out without any explicit commercial terms. Given this definition, valid examples of communities would therefore be newsgroups, chat groups, professional associations, support groups, organizations such as corporations, university or government departments, non-government organizations of various kinds, social and voluntary groups, etc; this definition would exclude communities formed for the primary purpose of formal education, lawyer-client relationships (including pro-bono relationships), libraries, contests and competitions of various kinds, internet based (or otherwise) provider-subscriber services such as paid magazines, bulletins, news wires, etc.

### BRIEF DESCRIPTION OF THE DRAWINGS

FIG. 1 is a block diagram illustrating the various components of a knowledge repository.

FIG. 2 illustrates a multi-dimensional knowledge hierarchy.

FIG. 3 illustrates the publication system.

FIG. 4 shows an overview of the review and rating system.

FIG. 5 illustrates the knowledge asset rating calculator.

FIG. 6 illustrates the member rating calculator.

FIG. 7 illustrates the search and retrieval system.

FIG. 8 illustrates the points redemption system.

FIG. 9 shows an overview of the preferred embodiment.

FIG. 10 shows the general computer network on which the invention might be practiced.

FIG. 11 shows the basic internal structure of the computing devices that make up the computer network as described in FIG. 10.

Appendix A shows snapshots of computer screens from the preferred embodiment.

### DETAILED DESCRIPTION OF THE DRAWINGS

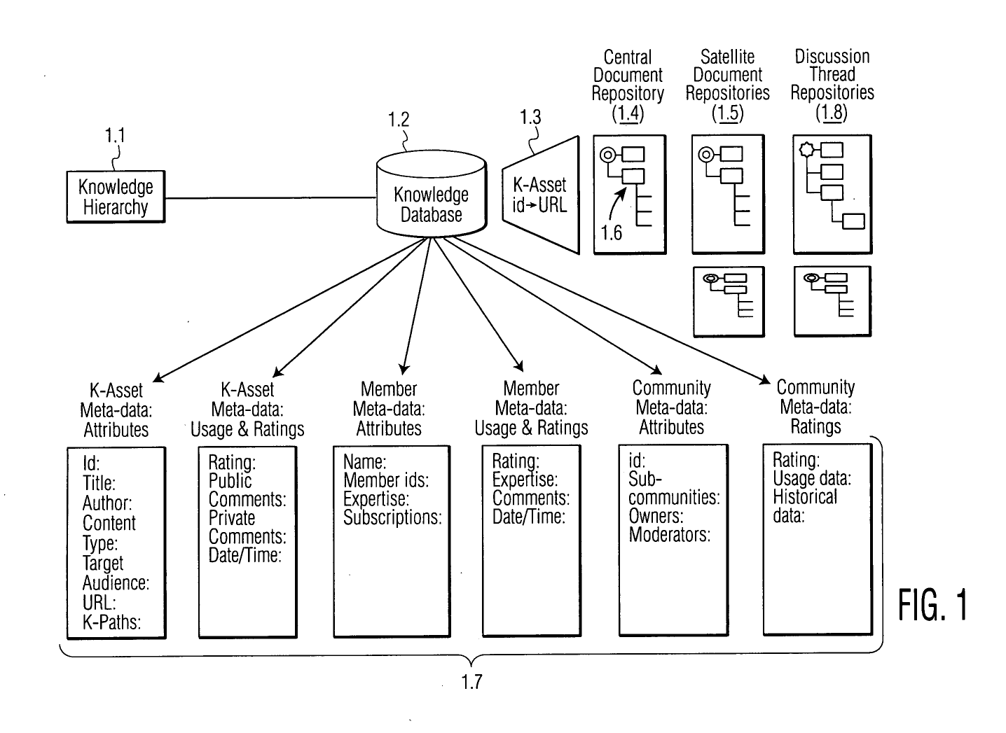

FIG. 1 is a block diagram illustrating a Knowledge Repository. The knowledge repository is a knowledge database (1.2) arranged in an hierarchical (1.1) manner. Knowledge database comprises a collection of Knowledge Assets (1.3). A knowledge asset is any document, a thread of messages in a discussion, an expertise profile of a member, or a transcript or record of a session of collaboration among members. A document can be an article, a whitepaper, a presentation, a webpage, a piece of program code, a spreadsheet, or any write-up in any language and in any format. Documents are stored either in printed form or in a computer file system. Documents can be stored in a central document repository (1.4) or in any of a plurality of satellite document repositories (1.5). Each repository has a hierarchy of folders and sub-folders that classify the documents according to a predetermined classification scheme (1.6).

Further each knowledge asset has associated meta data (1.7). Meta-data contains information about knowledge assets, members, about the usage of knowledge assets by members and about knowledge-sharing interactions between members.

Meta data in the preferred embodiment comprises:

K-Asset Meta-Data: Attributes

Each knowledge asset is identified by a primary key which is a unique alphanumeric serial number assigned to that asset. In addition, each asset has a (plurality of) member(s) who created the asset, a URL or other location descriptor that identifies the normal location of the asset in the repositories, the date and time when the asset was published in the repository, and a (plurality of) knowledge path(s) from the knowledge hierarchy that constitute(s) the classification of the asset in the knowledge repository. In addition, a knowledge asset may contain a variety of other attributes that are of interest to the knowledge sharing community, such as a title, an abstract, and a set of keywords.

K-Asset Meta-Data: Usage and Ratings

Each knowledge asset has a composite rating at any point of time. In addition, ratings given to it by any member at any point in time, along with any private and public comments given by the member, and date and time the rating was given are stored. A rating is any numeric value in a range that is predefined for the type of knowledge asset.

Member Meta-Data: Attributes

Each member is identified by a unique primary key which is an alphanumeric serial number assigned to that member. In addition, a member's name and contact information, such as the member's email id, telephone numbers, and addresses may be stored. The member's affiliations with various departments and organizations may also be stored here.

A member has a composite rating at any point of time. In addition, if redemption of rewards is included, the portion of the member's rating that is eligible for redemption is stored.

A member may also be associated with a profile which comprises the member's qualifications, prior experiences relevant to the community, areas of expertise, memberships in other communities, and subscriptions to classes of knowledge assets.

Member Meta-Data: Usage and Ratings

All ratings given by members to a particular member are stored along with the receiving member's meta-data. Ratings can be for documents written by the member, discussion threads to which the member had contributed, or collaboration sessions where the member shared knowledge with other members.

Community Meta-Data: Attributes

Each community has a unique primary key, which is an alphanumeric serial number assigned to that community. A community also has a name and an (a plurality of) identified owner(s) among the members of the community. Optionally, a community may also have sub-communities and a (plurality of) moderator(s) from among the members of the community.

Community Meta-Data: Usage and Ratings

Each community has an aggregate rating derived from the summation of the ratings given to all its members. Usage of the community's knowledge by other communities is also part of the community's meta-data. Such usage can be derived from usage of the community's documents or knowledge sharing in collaboration sessions by members of other communities in the organization.

Knowledge Hierarchy defines the classification scheme for the knowledge database. It is a multi-dimensional hierarchical arrangement of topics and other attributes that are of interest to the knowledge-sharing community. The knowledge hierarchy may contain multiple directed acyclic graphs for each dimension of classification. Dimensions may be broad topic areas (2.4), type of document (e.g., article or webpage or software code) (2.1), language, format (2.3), or any other parameter of interest to the community. It might also define the target audience of the document (2.2). As an example of a knowledge area (2.4), Technology comprises the subareas of Databases, Internet Technology and the like. Further the subarea Database might contain areas such as SQL, Oracle and the like. A particular path from a root node to a given node, called a Knowledge Path (2.5), rather than simply the node itself, uniquely identifies a particular classification.

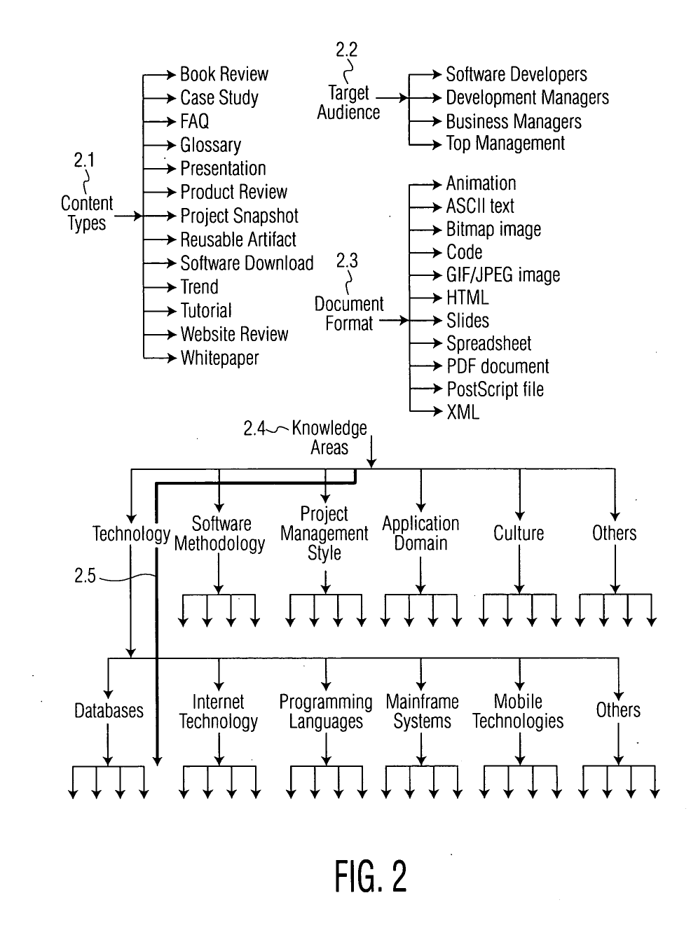

FIG. 2 shows a knowledge hierarchy from the preferred embodiment comprising the four dimensions of content type (2.1), document format (2.3), target audience (2.2), and knowledge area (2.4). Knowledge areas are classified into a four-level hierarchy comprising six separate directed acyclic graphs. A knowledge asset is classified by assigning to it one or more knowledge paths in the knowledge hierarchy. An embodiment may mandate some types of knowledge assets to be classified along specific dimensions. For example, every document must belong to one and only one content type. The set of knowledge paths assigned to a knowledge asset determines its type. All knowledge assets having the same knowledge paths in a particular dimension are said to be of the same type in that dimension. For example, all whitepapers are of the same type.

A knowledge repository also defines the range of ratings allowed for each type of knowledge asset. For example, whitepapers may have a range of 0 to 10 while book reviews have a range of 0 to 4. A knowledge asset need not be stored in a separate computer file. For example, discussion threads may be stored either in individual computer files or together in a computer database (called Discussion Thread Repositories in FIG. 1). Similarly, expertise profiles of members, although considered knowledge assets, may be stored entirely in the database along with all meta-data about members.

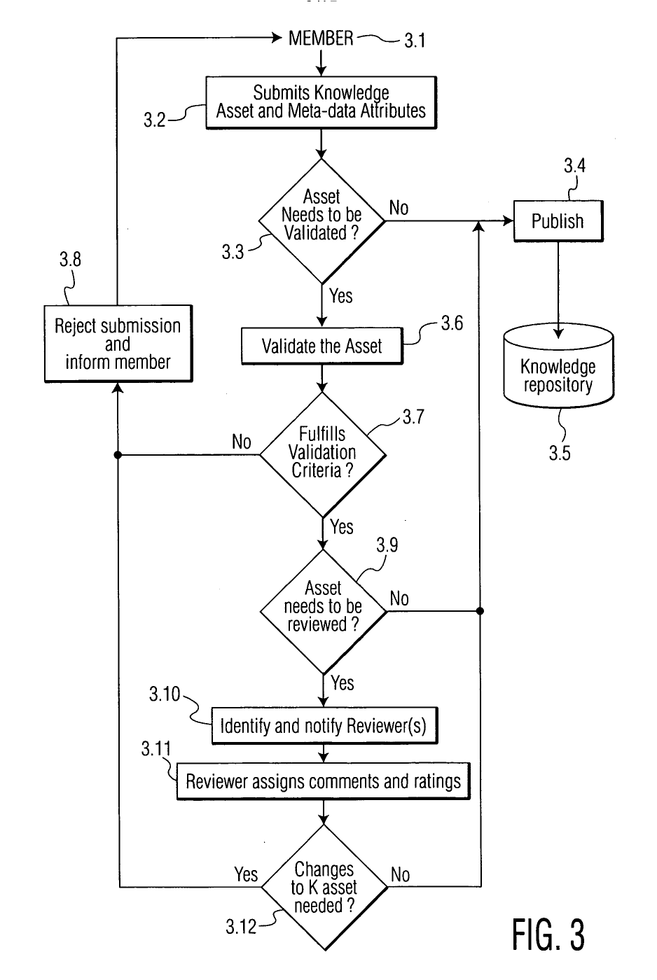

FIG. 3 is a flowchart illustrating the publication system of a knowledge asset. Members (3.1) submit knowledge assets and the corresponding meta-data attributes (3.2). Each asset is authored by one or more members. At the time of submission, authors provide a mapping from the knowledge asset to one or more nodes in the knowledge hierarchy along various dimensions of the knowledge hierarchy, such as its content type, topic, or target audience.

Other members of the community can see the submissions once they are published on the knowledge repository (3.5). Publication may optionally require a validation (3.3) and a review (3.9). If it does not require a validation the asset is published (3.4) in the knowledge repository (3.5). Else the asset is validated (3.6). The asset is checked to determine if it fulfills the validation criteria (3.7). If it does not fulfill the validation criteria then the asset is rejected and the concerned member/s is/are informed (3.8).

Validation may be for the purpose of checking sanity, readability, authenticity, originality, possible violation of intellectual property rights of others, etc. Validation is done by an assigned member of the community (such as its leader, moderator) or by an assigned content editor.

An asset is checked to determine if it needs to be reviewed (3.9). If not, then the asset is published (3.4) in the knowledge repository (3.5). If the asset needs to be reviewed then the reviewer(s) are identified and notified (3.10). The reviewer(s) assign(s) comments and ratings to the asset (3.11) and also determines whether the asset needs to be changed (3.12) before it can be published. If changes are necessary, concerned member(s) is/are notified (3.8). Else, the asset is published (3.4) in the repository (3.5).

Knowledge assets are published with a default rating at a predetermined percentage of the maximum rating allowed for the type of the knowledge asset. For example, the percentage of default rating may be 60%. A review may also include an optional quality review by an (a plurality of) assigned reviewer(s). The quality review may also result in rejecting the submission. A rejected knowledge asset is not available to other members of the community. Quality reviews are done by assigned reviewers who are also members of the community. Quality reviews may be required before publication or it may happen after publication, depending on the type of knowledge asset and the decisions made by the leader, moderator, or members of the community.

Reviewers assign a rating to the knowledge asset they review in a range of values with a maximum value that is predetermined for the type of the knowledge asset. Once an assigned reviewer gives a rating to a knowledge asset, its default rating is voided. If multiple reviewers rate a knowledge asset, the arithmetic mean of their ratings is applied to calculate the overall rating of the knowledge asset.

Reviewers can demand changes to the knowledge asset. In such a case, the moderator, editor, or the author(s) of the knowledge asset must make the changes and resubmit the knowledge asset even if it is already published. In such cases, earlier versions of the knowledge asset will no longer be accessible to members of the community.

An author may also choose to submit a new version of an already published knowledge asset. The new version goes through the same validation, review, and publication process. A community may decide to make both the new version and older versions of a knowledge asset available to the members of the community, or it may decide to publish only the latest version of a knowledge asset (sometimes depending on the type of the knowledge asset).

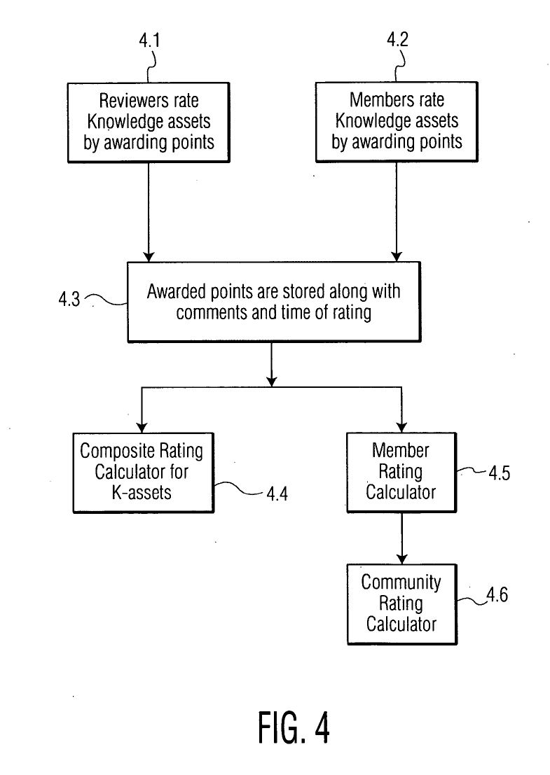

FIG. 4 shows an overview of how ratings are calculated for knowledge assets, members, and communities. The point rating system allows members of the community to rate knowledge assets by awarding points on predetermined scales. These points are awarded by the reviewers (4.1) as well as members of the community (4.2). These points are stored alongwith the comments and time of rating (4.3). The points thus awarded are used for the calculation of aggregate ratings of both members (4.5) and knowledge assets (4.4). Member ratings are further aggregated to calculate community ratings (4.6).

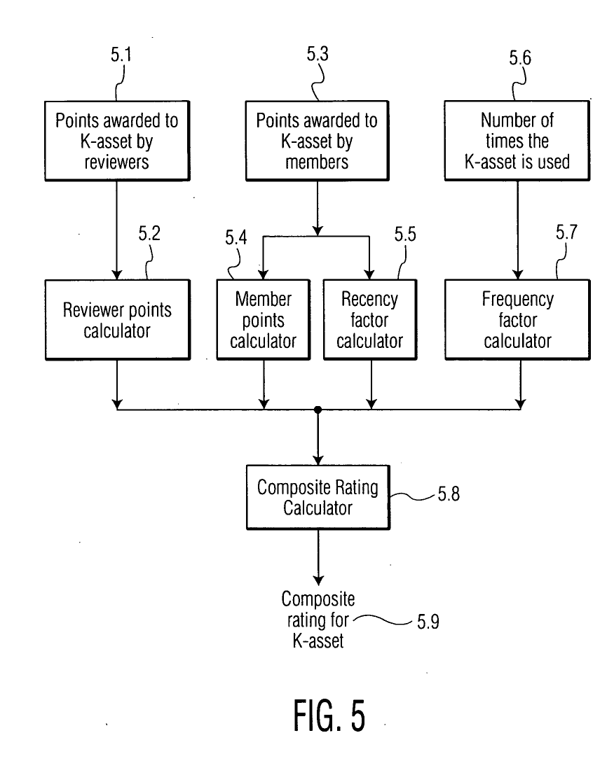

FIG. 5 shows the knowledge asset composite rating calculator that computes a rating Pₖ₋ₐₛₛₑₜ for a published knowledge asset based on the ratings awarded to the asset by reviewers (5.1) and members (5.3) of the community. The calculator also takes into account the number of times the knowledge asset is used (5.6) to calculate the frequency factor (5.7). It also calculates the recency factor (5.5). In step 5.2, the arithmetic mean of the ratings given by reviewers to the knowledge asset, normalized to a scale of 0 to 10, is the aggregate rating from reviewers P_{reviewer}. Similarly in step 5.4, the arithmetic mean of the ratings by members, normalized to a scale of 0 to 10, is the aggregate rating from members P_{member}. The recency factor P_{frequency} is computed (5.5) by reducing successive older ratings awarded by members to the K-asset by associating progressively diminishing weights with each such rating, such weights governed by an equation that ensures smoothness in their decrements. The frequency factor P_{frequency} is computed (5.7) based on the number of times the knowledge asset is used relative to all other published assets of the same type.

The composite of all these ratings (5.8) forms the rating for the knowledge asset (5.9).

In the preferred embodiment, the composite rating of a knowledge asset is computed by the following formula:

$${P}_{k \text{-} asset} = 0.4 * {P}_{reviewer} + 0.3 * {P}_{member} + 0.1 * {P}_{recency} + 0.2 * {P}_{frequency}$$

$$where {P}_{frequency} = ( 1 - {ⅇ}^{- λ x} ) * 10$$

$$where$$

$$x = usage index = \frac{\# ratings for the K \text{-} asset}{Average ( \# ratings for K \text{-} assets of same type )}$$

where, X=a constant

P_{recency} is computed by considering time windows of equal duration (3 months in the preferred embodiment). The number of time windows represented by “n”, will be in the range 1 to 6. Ratings awarded by members are grouped within the boundaries of each time window i and the respective arithmetic means Rᵢ calculated. Each mean is associated with progressively diminishing weights but maintaining the sum of weights as 1. The weighted average of ratings from all relevant time windows is P_{recency}.

For example, if the current window is weighted by a number a,
0.5<=a<=1.0,
the previous consecutive window will be weighted by a*(1−a) and the next successive older period as a*(1−a)² and so on. In other words, the weights are decremented in an exponential manner, the last weight being
1−[a+a*(1−a)+a(1−a)²+ . . . a*(1−a)⁽ⁿ⁻¹⁾]

If there is a time window for which there is no member rating for the asset, the mean rating belonging to the more recent window successive to the empty window is used for the calculation. In case there are only two successive time windows available, the weights assigned will be “a” for the current window and “(1−a)” for the past one.
P_{recency}=a*R₁+a*(1−a)*R₂+ . . . +a*(1−a)ⁱ⁻¹*Rᵢ+ . . . +{1−[a+a(1−a)+ . . . +a(1−a)⁽ⁿ⁻¹⁾]}*Rₙ

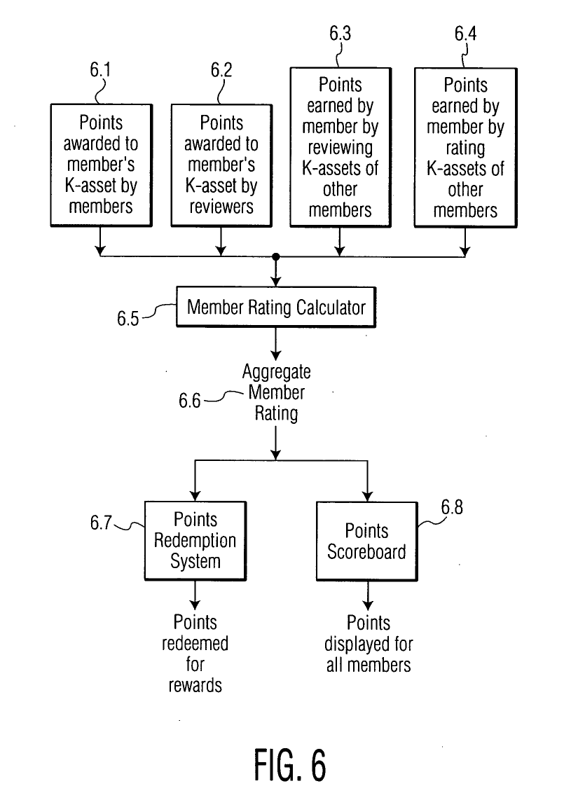

FIG. 6 shows the member rating calculator which aggregates the points earned by a member through one or more of the following means:
1. The sum P_{member}_{_{—}}_{rating} of the ratings given by other members to a K-asset authored by the member (6.2).
2. The sum P_{reviewer}_{_{—}}_{rating} of the ratings given by reviewers to a K-asset authored by the member (6.1).
3. The sum P_{review} of the points earned by the member for reviewing K-assets of submitted by other members (6.3).
4. The sum P_{rating} of the points earned by the member for rating published K-assets available in the community (6.4).

The aggregate rating of the member (6.6) is calculated (6.5) as:
P_{member}=P_{reviewer}_{_{—}}_{rating}+P_{member}_{_{—}}_{rating}+P_{review}+P_{rating}

These points could be redeemed by the member (6.7) and also be displayed (6.8).

The aggregate rating of an entire community is calculated as the sum of the aggregate ratings of all members of the community. If a member belongs to more than one community or to a community and several of its sub-communities, the member has separate ratings in each community or sub-community.

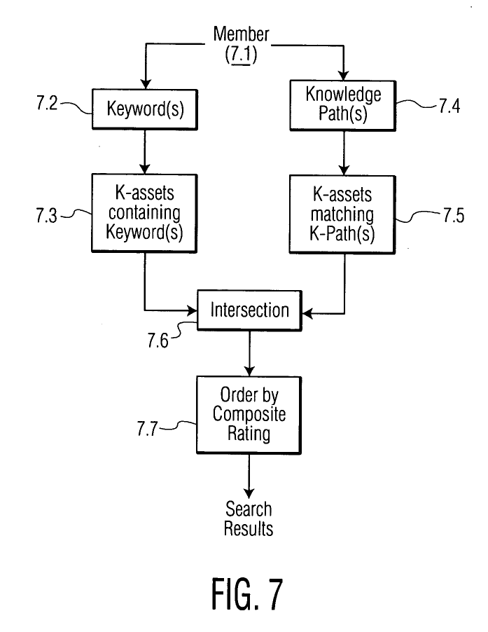

FIG. 7 shows the search and retrieval system. In a keyword-based search system (7.2), documents are retrieved in the order of their relevance to a member's (7.1) query. The knowledge hierarchy outlined in this invention where knowledge assets are organized and retrieved using a multidimensional knowledge hierarchy, search keywords can be combined with knowledge paths (7.4) selected by the user from the knowledge hierarchy. Those knowledge assets are selected (7.6) that contain the keywords (7.3) and also match the selected knowledge paths (7.5). Selected knowledge assets can be ordered based on the relative significance of assets as measured by their composite ratings in the community (7.7).

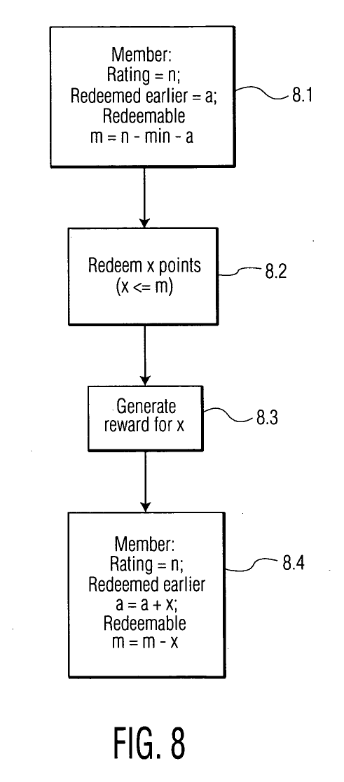

FIG. 8 shows the points redemption system. The knowledge repository contains a scoreboard that shows every member's accumulated points. The scoreboard also shows the aggregate scores of the entire community and any of its sub-communities thereby providing recognition to both members and sub-communities. The scoreboard also shows a break-up of scores into those obtained by being authors of knowledge assets, those obtained by reviewing other members' assets, and those obtained for providing collaboration in knowledge sharing sessions. A member can see both his/her scores as well as the scores of some of the highest scorers in the community.

In the preferred embodiment, members can redeem their accumulated points to obtain various rewards predetermined by the community. For example, points can be redeemed for cash, gift certificates, or other material goods. The member's total score of points will continue to be the same after redemption although a point can be redeemed only once for some types of rewards. For example, redemption in exchange for cash or its equivalents can be done only once, but the same points can be accumulated and redeemed multiple times to obtain plaques or certificates for predetermined milestones in points.

FIG. 8 shows the point redemption system. As shown in 8.1 a member with rating ‘n’ and with ‘a’ points redeemed earlier, has ‘m’ redeemable points where m=n−min−a, where ‘min’ is the minimum number of points predetermined by the community, only above which the member can redeem points. It may be noted that the term ‘m’ is required to be positive (i.e., m>0) for redemption of points by the member to be possible. After a member redeems ‘x’ points where x<=m (8.2) for generating rewards equivalent to ‘x’ (8.3) the redeemed points are updated as ‘a+x’ and redeemable as ‘m-x’ (8.4).

In the preferred embodiment, the knowledge management system in a global information technology services company has set up sub-communities along organizational divisions such as departments and practice units for its community of employees across the globe. The communities apply the metric disclosed here to measure the utility of knowledge assets as perceived by employees of the community and also to rate the contributions of members and sub-communities to knowledge sharing within the company. The aggregate rating of the entire community is used as a measure of progress in implementing knowledge management across the company. All employees are connected through a network of computers across all locations where the company operates. This computer network is isolated from the Internet by firewalls to form an intranet. Members access knowledge assets and submit new assets through a central website on the intranet that acts as a knowledge portal. Members can also search and identify members who are experts in particular topics. Members can communicate with each other through electronic mails, telephones, and through on-line discussion forums for various topics. Every member has a unique employee number as well as an e-mail id that can be readily found in an on-line employee directory. Every member has a set of organizational attributes that include their employment grade, their current roles such as developers, business managers, etc., and their affiliations with projects, departments, and business units.

The knowledge repository is hosted on the knowledge portal. The repository stores the files that contain the knowledge and all the meta-data in a relational database. The Knowledge hierarchy used in this embodiment is shown in FIG. 2. Knowledge assets are classified by assigning a content type, a target audience, and 1 to 6 knowledge paths in the topic dimension. Some knowledge assets also have keywords and abstracts associated with them.

All employees have an on-line profile which they can voluntarily modify to include their current expertise.

Review and ratings mechanisms and the calculations of various aggregate ratings in this embodiment have been described in the Detailed Descriptions of figures above.

In this embodiment, members can redeem their points above a minimum of 25 points to obtain electronic gift certificates. These certificates can be used at an e-commerce site on the Internet to purchase books, music, or other artifacts and services.

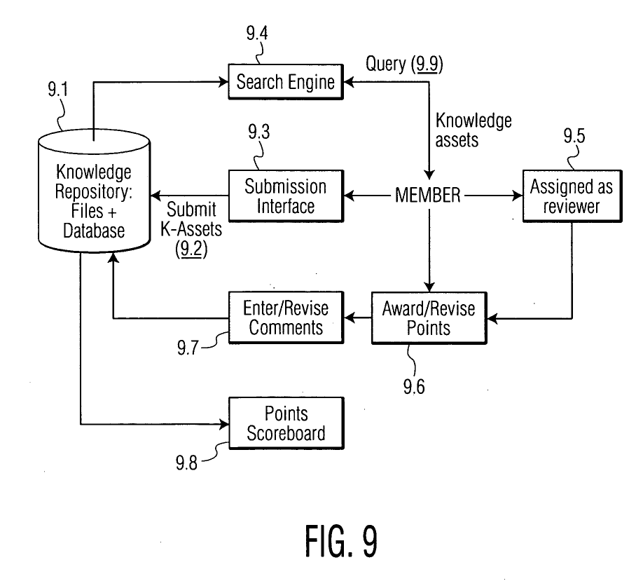

FIG. 9 shows a general block diagram of the preferred embodiment implementing the above mentioned publishing and review schemes for the knowledge assets. The core of the system is formed by a Knowledge Repository (9.1). Members (9.2) submit the knowledge asset to this database through submission interface (9.3). Some of these members who are assigned as reviewers (9.5) can award/revise points (9.6) or enter/revise (9.7) comments to the knowledge asset in the repository. Further, members can query (9.9)_the knowledge repository (9.1) through a search engine (9.4) to retrieve the knowledge assets relevant to them. The member points are also stored in the Knowledge Repository database that is used by a Points Scoreboard (9.8) to display the member points.

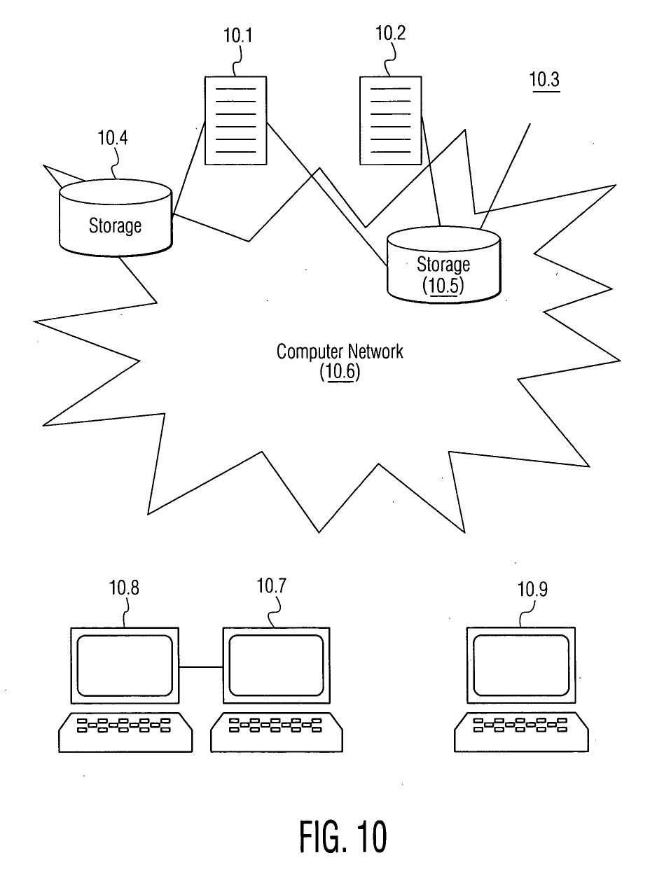

FIG. 10 shows a general computer network (10.6) on which the invention might be practiced. It consists of a bunch of servers (10.1, 10.2, 10.3) interconnected by any known communication means such as by wired means, radio links or infrared transmissions. The networking topology could be any known one in the art like star, linear, ring and the like, or a combination of these. Further, in order to communicate, these servers could use any of the known communication protocols such as TCP/IP, Ethernet and the like. These servers could either have a dedicated storage (10.4) or two or more servers might share a storage (10.5). User workstations (10.7, 10.8, 10.9) are connected to the network (10.6) and contact one or more servers for the retrieval of the data stored therein. Here too, the interconnection could be through any means, topology and follow any protocol. Further, the user workstations can be indirectly connected to the network by virtue of being interconnected to each other. The computer network could be any type of network, public or private. Using a combination of these networks it is possible to make full or part of the information stored on the servers available to a roaming user. There could be specific servers on the public network or one can connect to the private network through a public network using technologies such as Virtual Private Network. Further the number of servers and the workstations is not limited and the data can reside either on one server or it could be distributed over a number of servers. Also some specific data can reside on the user workstations also.

The invention can be practiced on any general computer system. The clients and servers could be any computing device. The computer system comprises a display device with a display screen Examples of display device are Cathode Ray Tube (CRT) devices, Liquid Crystal Display (LCD) devices etc. The computer system can also have other additional output devices like a printer. The cabinet houses the additional essential components of the computer system such as the microprocessor, memory and disk drives. In a general computer system the microprocessor is any commercially available processor for which ×86 processors from Intel and 680X0 series from Motorola are examples. Many other microprocessors are available. The computer system could be a single processor system or may use two or more processors on a single system or over a network. The microprocessor for its functioning uses a volatile memory that is a random access memory such as dynamic random access memory (DRAM) or static memory (SRAM). The disk drives are the permanent storage medium used by the computer system. This permanent storage could be a magnetic disk, a flash memory and a tape. This storage could be removable like a floppy disk or permanent such as a hard disk. Besides this, the cabinet can also house other additional components like a Compact Disc Read Only Memory (CD-ROM) drive, sound card, video card etc. The computer system also has various input devices like a keyboard and a mouse. The keyboard and the mouse are connected to the computer system through wired or wireless links. The mouse could be a two-button mouse, three-button mouse or a scroll mouse. Besides the said input devices there could be other input devices like a light pen, a track ball etc. The microprocessor executes a program called the operating system for the basic functioning of the computer system. The examples of operating systems are UNIX, WINDOWS and DOS. These operating systems allocate the computer system resources to various programs and help the users to interact with the system. It should be understood that the invention is not limited to any particular hardware comprising the computer system or the software running on it.

The servers are generally high end computing system with greater reliability and speed whereas the user workstations could be electronic devices like personal computers, mobile phones, interactive televisions and the like.

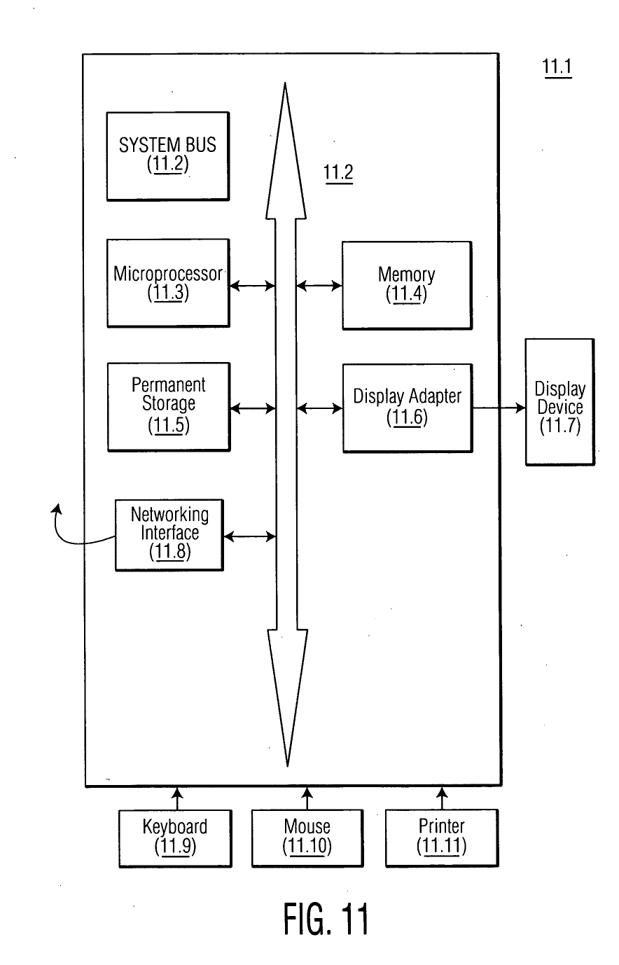

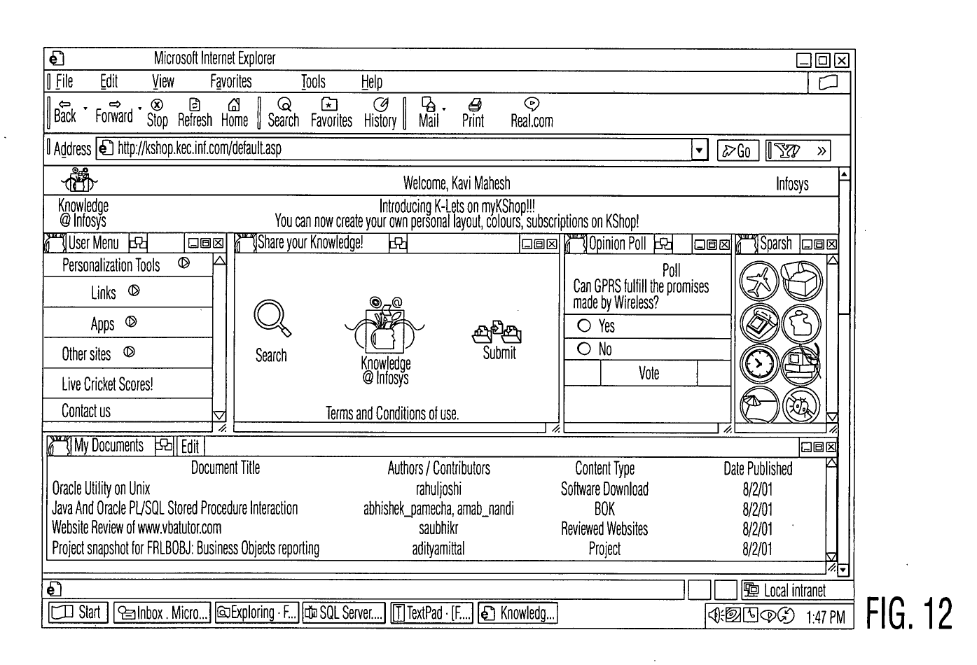

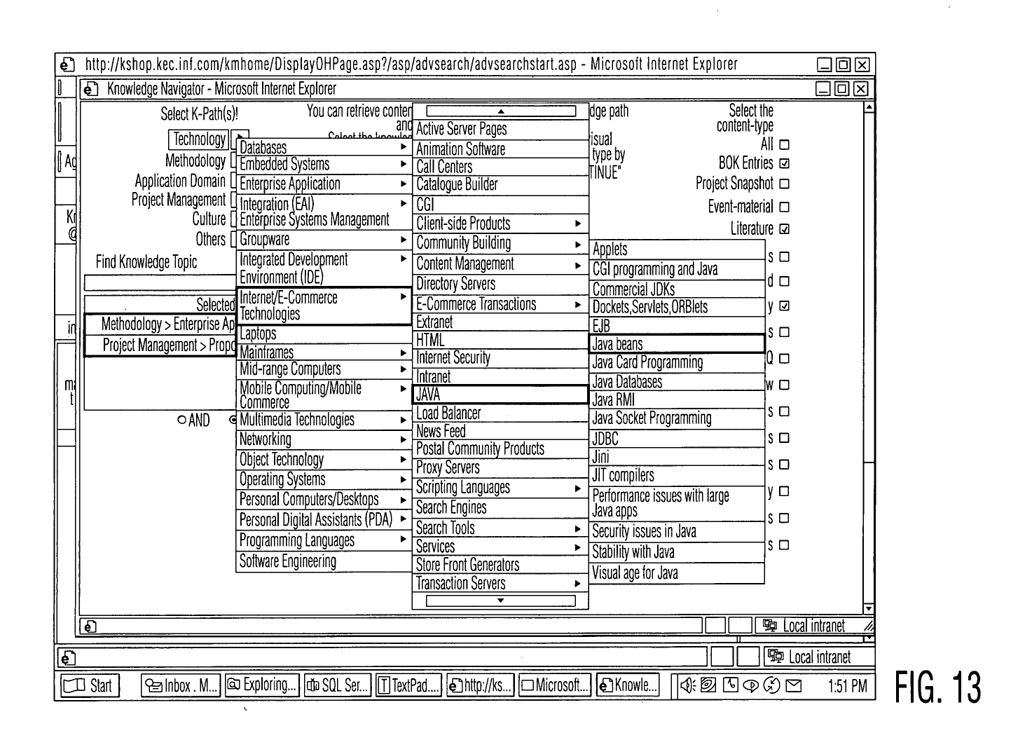

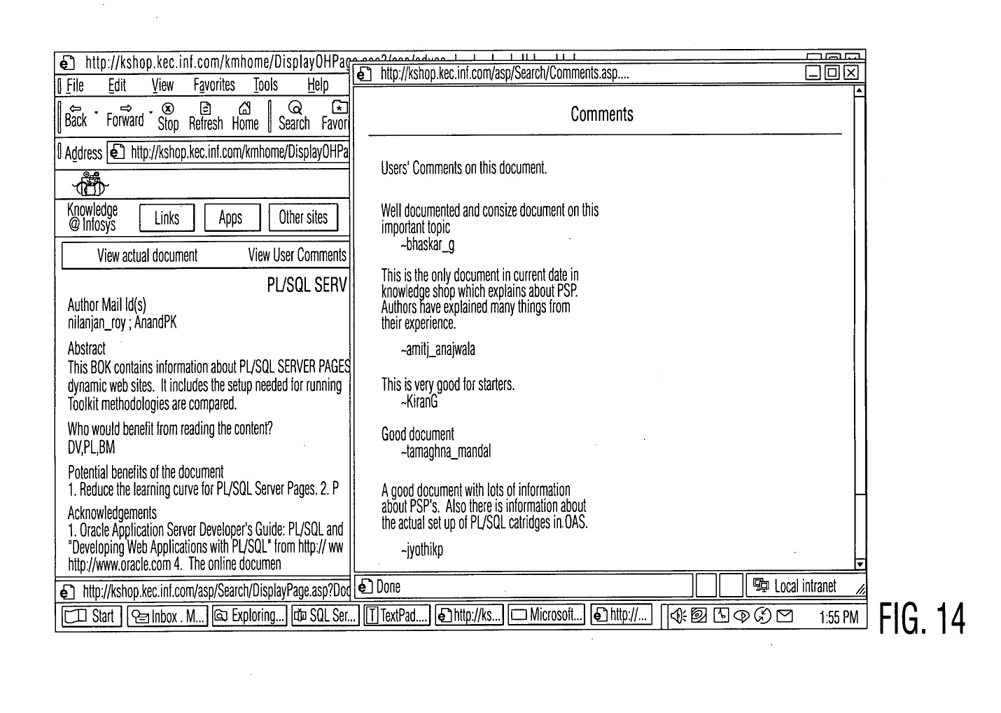

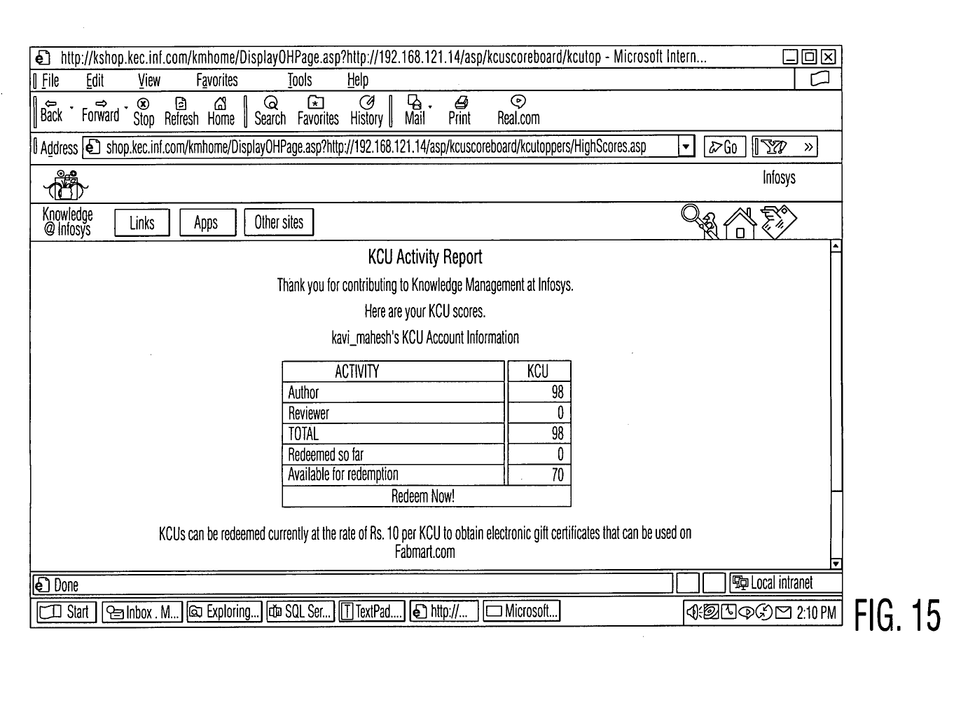

FIG. 11 shows the internal structure of the general computer system as described above. The computer system (11.1) consists of various subsystems interconnected with the help of a system bus (11.2). The microprocessor (11.3) communicates and controls the functioning of other subsystems. Memory (11.4) helps the microprocessor in its functioning by storing instructions and data during its execution. Permanent Storage (11.5) is used to hold the data and instructions permanent in nature like the operating system and other programs. Display adapter (11.6) is used as an interface between the system bus and the display device (11.7), which is generally a monitor. The network interface (11.8) is used to connect the computer with other computers on a network through wired or wireless means. The computer system might also contain a sound card (not shown). The system is connected to various input devices like keyboard (11.9) and mouse (11.10) and output devices like printer (11.11). Various configurations of these subsystems are possible. It should also be noted that a system implementing the present invention might use less or more number of the subsystems than described above.

Those of ordinary skill in the art will appreciate that the various means described are instructions for operating on the computing system. The means are capable of existing in an embedded form within the hardware of the system or may be embodied on various computer readable media. The computer readable media may take the form of coded formats that are decoded for actual use in a particular information processing system. Computer program means, or a computer program in the present context means, any expression, in any language, code, or notation, of a set of instructions intended to cause a system having information processing capability to perform the particular function either directly or after performing either or both of the following:

a) conversion to another language, code or notation

b) reproduction in a different material form.

The depicted example in FIGS. 10 and 11 is not meant to imply architectural limitations and the configuration of the incorporating device of the said means may vary depending on the implementation. Any kind of computer system or other apparatus adapted for carrying out the means described herein can be employed for practicing the invention. A typical combination of hardware and software could be a general purpose computer system with a computer program that when loaded and executed, controls the computer system such that it carries out the means described herein. Other examples of the incorporating device that may be used are notebook computers or hand held computers in addition to personal digital assistants (PDAs), web kiosks or even Web appliances.

1. An automated method for measuring benefits accruing from the management of knowledge in a self-assessing knowledge sharing community, or a plurality of communities and sub-communities said method comprising the steps of:
storing knowledge assets in a repository, preferably in a computer-readable format,
cataloguing of knowledge assets for easy retrieval by classifying them against a multi-dimensional knowledge hierarchy,
receiving new knowledge assets from members of the community,
validating, reviewing and rating of the new knowledge assets by assigned members of the community,
storing and publishing the validated knowledge in the repository,
reviewing and rating of published knowledge assets by any member of the community,
calculating a composite rating for knowledge assets based on an aggregation of ratings and usage over time of the knowledge assets in the community,
calculating an aggregate rating for a member in each community based on the contributions of the member to the community,
calculating an aggregate rating for each community based on the ratings of all its members, and
calculating and displaying on a scoreboard, various ratings for members, communities, and sub-communities.

2. The method as claimed in claim 1, wherein knowledge assets include documents, discussion threads, profiles of experts, and records of knowledge sharing sessions.

3. (canceled)

4. The method as claimed in claim 1, wherein cataloguing of knowledge assets is determined by a multidimensional knowledge hierarchy used for the classification of all types of knowledge assets in the knowledge repository including expert profiles, for the selection of reviewers for reviewing submitted assets, and for the organization of sub-communities into communities.

5. (canceled)

6. The method as claimed in claim 1, wherein the rating and reviewing of knowledge assets by assigned members at the time of publishing comprises the steps of:
selecting one or more reviewers by matching the knowledge nodes and paths of the asset with those of the expert profiles of members in the community, using the knowledge hierarchy,
assigning of ratings to the knowledge assets by the reviewer(s), and
entering of comments by the reviewer visible to all members of the community as well as private comments visible only to the author(s) of the knowledge asset.

7. (canceled)

8. The method as claimed in claim 6, wherein the step of assignment of ratings by a reviewer to the knowledge asset includes:
normalizing the rated points to a scale of points whose range is determined by the type of the knowledge asset, and,
awarding the rated points to each of the author(s) of the knowledge asset either in their entirety or with an apportionment in the case of a plurality of authors.

9. The method as claimed in claim 6, wherein a predetermined fraction of the maximum number of points possible in the range of points for the type of the reviewed knowledge asset is accrued to the reviewer(s).

10. The method as claimed in claim 1, wherein reviewing and rating of a knowledge asset after publishing can be conducted by any member of the community other than an author or reviewer of the knowledge asset along with comments that are accessible to all members of the community.

11. (canceled)

12. (canceled)

13. The method as claimed in claim 10, wherein the ratings assigned by a member to a knowledge asset includes:
normalizing the rated points to a scale of points whose range is determined by the type of the knowledge asset, and,
accrual of the rated points to each of the authors of the knowledge asset either in their entirety or with an apportionment in case of a plurality of authors.

14. The method as claimed in claim 10, wherein a predetermined fraction of the maximum number of points possible in the range of points for the type of the knowledge asset rated is accrued to the member who contributes the rating.

15. The method as claimed in claim 1, wherein calculating the composite ratings of knowledge assets comprises the steps of calculating,
reviewer ratings as the arithmetic mean of all the reviewer ratings given to the knowledge asset,
member ratings as the arithmetic mean of all the member ratings given to the knowledge asset,
frequency of usage as a fraction in exponential relation to the ratio of the number of times the knowledge asset is used by members to the arithmetic mean of the numbers of times all knowledge assets of the same type in the community are used by members,
recency of usage as a discrete integral over time of the product of the arithmetic mean of the ratings given to the knowledge asset by members in a window, from a set of windows of equal time intervals, and a corresponding fraction from a predetermined set of time-varying fractions that sum up to 1.0.
the weighted sum of the reviewer rating, member rating, frequency of usage and recency of usage, where the weight for reviewer rating is greater than the weight for member rating and the sum of the four weights is equal to 1.0,
the composite rating for the knowledge asset as the weighted sum normalized to a predetermined scale.

16. The method as claimed in claim 15 wherein the weighted sum is normalized on a scale of 1 to 10.

17. (canceled)

18. The method as claimed in claim 1, wherein calculating the aggregate rating of a member or a former member in a particular community further comprises the steps of calculating:
reviewer accruals as zero for former members and, for current members, as the sum of the points, over all reviews of knowledge assets done by the member in the community or any of its sub-communities,
member rating accruals as zero for former members and, for current members, as the sum of the points, over all ratings of knowledge assets in the community or any of its sub-communities done by the member,
author accruals from reviewers as the sum of the points, over all reviews of knowledge assets authored by the member in the community or any of its sub-communities,
author accruals from reviewers as the sum of the points, over all reviews of knowledge assets authored by the member in the community or any of its sub-communities,
author accruals from members as the sum of the points, over all ratings of knowledge assets authored by the member in the community or any of its sub-communities, and
the aggregate rating as the sum of the reviewer accruals, member rating accruals, author accruals from reviewers and author accruals from members.

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. An automated system for measuring benefits accruing from the management of knowledge in a self-assessing knowledge sharing community, or a plurality of communities and sub-communities, comprising:
a repository for storing knowledge assets preferably in a computer-readable format,
a catalogue for cataloguing the knowledge assets for easy retrieval by classifying them against a multi-dimensional knowledge hierarchy,
means for receiving new knowledge assets from members of the community,
means for validating, reviewing and rating of the new knowledge assets by assigned members of the community,
means for storing and publishing the validated knowledge in the repository,
means for reviewing and rating of published knowledge assets by any member of the community,
calculating means for a composite rating for knowledge assets based on an aggregation of ratings and usage over time of the knowledge assets in the community,
calculating means for an aggregate rating for a member in each community based on the contributions of the member to the community,
calculating means for an aggregate rating for each community based on the ratings of all its members, and
means for calculating and displaying on a scoreboard various ratings for members, communities, and sub-communities.

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. A computer program product comprising computer readable program code stored on computer readable storage medium embodied therein for providing an automated system for measuring benefits accruing from the management of knowledge in a self-assessing knowledge sharing community, or a plurality of communities and sub-communities, comprising:
computer readable program code configured for storing knowledge assets in a repository, preferably in a computer-readable format,
computer readable program code configured for cataloguing the knowledge assets for easy retrieval by classifying them against a multi-dimensional knowledge hierarchy,
computer readable program code configured for receiving new knowledge assets from members of the community,
computer readable program code configured for validating, reviewing and rating of the new knowledge assets by assigned members of the community,
computer readable program code configured for storing and publishing the validated knowledge in the repository,
computer readable program code configured for reviewing and rating of published knowledge assets by any member of the community,
computer readable program code configured for calculating a composite rating for knowledge assets based on an aggregation of ratings and usage over time of the knowledge assets in the community,
computer readable program code configured for calculating an aggregate rating for a member in each community based on the contributions of the member to the community,
computer readable program code configured for calculating an aggregate rating for each community based on the ratings of all its members, and
computer readable program code configured for calculating and displaying on a scoreboard various ratings for members, communities, and sub-communities.

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. The method as claimed in claim 18, wherein a members current aggregate rating in a community is made accessible on the scoreboard to all members of the community.

78. The method as claimed in claim 1, wherein the aggregate rating of a community is calculated as the sum, over all members including former members of the community, of the aggregate ratings of each member in that community.

79. The method as claimed in claim 18, wherein the members in a community can redeem their points in exchange for rewards.

80. The method as claimed in claim 79 wherein the redeemable points of a member in a community are calculated as the sum of the reviewer accruals, author accruals and member rating accruals of the member, considering only the knowledge assets in the community and not those in sub-communities.

81. The method as claimed in claim 79, wherein a member can redeem some of his/her redeemable points to obtain multiple types of rewards at a rate of exchange of points to particular rewards predetermined by the community.

82. The method as claimed in claim 79, wherein multiple types of rewards are awarded to members on achieving predetermined milestones in their points in the community.

83. The system as claimed in claim 38, wherein knowledge assets include documents, discussion threads, profiles of experts, and records of knowledge sharing sessions.

84. The system as claimed in claim 38, wherein means for cataloguing of knowledge assets includes a multi-dimensional knowledge hierarchy used as the means for the classification of all types of knowledge assets in the knowledge repository including expert profiles, the means for the selection of reviewers for reviewing submitted assets, and the means for the organization of sub-communities into communities.

85. The system as claimed in claim 38, wherein means for rating and reviewing of knowledge assets by assigned members at the time of publishing comprises:
means for selecting one or more reviewers by matching the knowledge nodes and paths of the asset with those of the expert profiles of members in the community, using the knowledge hierarchy,
means for assigning of ratings to the knowledge assets by the reviewer(s), and
means for entering of comments by the reviewer visible to all members of the community as well as private comments visible only to the author(s) of the knowledge asset.

86. The system as claimed in claim 85, wherein means for assignment of ratings by a reviewer to the knowledge asset includes:
means for normalizing the rated points to a scale of points whose range is determined by the type of the knowledge asset, and
means for awarding the rated points to each of the author(s) of the knowledge asset either in their entirety or with an apportionment in the case of a plurality of authors.

87. The system as claimed in claim 38, further comprising means for reviewing and rating of a knowledge asset after publishing by any member of the community other than an author or reviewer of the knowledge asset along with comments that are accessible to all members of the community.

88. The system as claimed in claim 87, wherein means for assigning the rating by a member to a knowledge asset includes:
means for normalizing the rated points to a scale of points whose range is determined by the type of the knowledge asset, and,
means for accruing of the rated points to each of the authors of the knowledge asset either in their entirety or with an apportionment in the case of a plurality of authors.

89. The system as claimed in claim 38, wherein means for calculating the composite ratings of knowledge assets comprises:
means for calculating reviewer ratings as the arithmetic mean of all the reviewer ratings given to the knowledge asset,
means for calculating member ratings as the arithmetic mean of all the member ratings given to the knowledge asset,
means for calculating frequency of usage as a fraction in exponential relation to the ratio of the number of times the knowledge asset is used by members to the arithmetic mean of the numbers of times all knowledge assets of the same type in the community are used by members,
means for calculating recency of usage as a discrete integral over time of the product of the arithmetic mean of the ratings given to the knowledge asset by members in a window, from a set of windows of equal time intervals, and a corresponding fraction from a predetermined set of time-varying fractions that sum up to 1.0,
means for calculating the weighted sum of the reviewer rating, member rating, frequency of usage and recency of usage, where the weight for reviewer rating is greater than the weight for member rating and the sum of the four weights is equal to 1.0,
means for calculating the composite rating for the knowledge asset as the weighted sum normalized to a predetermined scale.

90. The system as claimed in claim 38, wherein means for calculating the aggregate rating of a member or a former member in a particular community further comprises:
means for calculating reviewer accruals as zero for former members and, for current members, as the sum of the points, over all reviews of knowledge assets done by the member in the community or any of its sub-communities,
means for calculating member rating accruals as zero for former members and, for current members, as the sum of the points, over all ratings of knowledge assets in the community or any of its sub-communities done by the member.
means for calculating author accruals from reviewers as the sum of the points, over all reviews of knowledge assets authored by the member in the community or any of its sub-communities,
means for calculating author accruals from members as the sum of the points, over all ratings of knowledge assets authored by the member in the community or any of its sub-communities, and
means for calculating the aggregate rating as the sum of the reviewer accruals, member rating accruals, author accruals from reviewers and author accruals from members.

91. The system as claimed in claim 38, wherein said means wholly or partially reside on a computing system comprising
at least one system bus,
at least one communications unit connected to the system bus,
a memory unit including a set of instructions connected to the system bus, and
at least one control unit executing the instructions in the memory for the functioning of said means.

92. The system as claimed in claim 91, further connected to other similar systems and database systems that may contain means to complement and supplement the already existing means.

93. The system as claimed in claim 92, wherein said systems are interconnected through any suitable computer network including Ethernet, Internet, LAN, WAN, and MAN using any desired network topology including ring, bus and star.

94. The computer program product as claimed in claim 59, wherein knowledge assets include documents, discussion threads, profiles of experts, and records of knowledge sharing sessions.

95. The computer program product as claimed in claim 59, comprising computer readable program code configured for cataloguing of knowledge against a multi-dimensional knowledge hierarchy used for the classification of all types of knowledge assets in the knowledge repository including expert profiles, for the selection of reviewers for reviewing submitted assets, and for the organization of sub-communities into communities.

96. The computer program product as claimed in claim 59, wherein computer readable program code for rating and reviewing of knowledge assets by assigned members at the time of publishing comprises:
computer readable program code configured for selecting one or more reviewers by matching the knowledge nodes and paths of the asset with those of the expert profiles of members in the community, using the knowledge hierarchy,
computer readable program code configured for assigning of ratings to the knowledge assets by the reviewer(s), and
computer readable program code configured for entering of comments by the reviewer visible to all members of the community as well as private comments visible only to the author(s) of the knowledge asset.

97. The computer program product as claimed in claim 96, wherein computer readable program code for assignment of ratings by a reviewer to the knowledge asset includes:
computer readable program code configured for normalizing the rated points to a scale of points whose range is determined by the type of the knowledge asset, and,
computer readable program code configured for awarding the rated points to each of the author(s) of the knowledge asset either in their entirety or with an apportionment in the case of a plurality of authors.

98. The computer program product as claimed in claim 59, further comprising computer readable program code configured for reviewing and rating of a knowledge asset after publishing by any member of the community other than an author or reviewer of the knowledge asset along with comments that are accessible to all members of the community.

99. The computer program product as claimed in claim 98, wherein computer readable program code for assigning the rating by a member to a knowledge asset includes:
computer readable program code configured for normalizing the rated points to a scale of points whose range is determined by the type of the knowledge asset, and,
computer readable program code configured for accruing of the rated points to each of the authors of the knowledge asset either in their entirety or with an apportionment in the case of a plurality of authors.

100. The computer program code as claimed in claim 59, wherein computer readable program code for calculating the composite ratings of knowledge assets comprises:
computer readable program code configured for calculating reviewer ratings as the arithmetic mean of all the reviewer ratings given to the knowledge asset,
computer readable program code configured for calculating member ratings as the arithmetic mean of all the member ratings given to the knowledge asset,
computer readable program code configured for calculating frequency of usage as a fraction in exponential relation to the ratio of the number of times the knowledge asset is used by members to the arithmetic mean of the numbers of times all knowledge assets of the same type in the community are used by members,
computer readable program code configured for calculating recency of usage as a discrete integral over time of the product of the arithmetic mean of the ratings given to the knowledge asset by members in a window, from a set of windows of equal time intervals, and a corresponding fraction from a predetermined set of time-varying fractions that sum up to 1.0,
computer readable program code configured for calculating the weighted sum of the reviewer rating, member rating, frequency of usage and recency of usage, where the weight for reviewer rating is greater than the weight for member rating and the sum of the four weights is equal to 1.0, and
computer readable program code configured for calculating the composite rating for the knowledge asset as the weighted sum normalized to a predetermined scale.

101. The computer program product as claimed in claim 59, wherein computer readable program code for calculating the aggregate rating of a member or a former member in a particular community further comprises:
computer readable program code configured for calculating reviewer accruals as zero for former members and, for current members, as the sum of the points, over all reviews of knowledge assets done by the member in the community or any of its sub-communities,
computer readable program code configured for calculating member rating accruals as zero for former members and, for current members, as the sum of the points, over all ratings of knowledge assets in the community or any of its sub-communities done by the member,
computer readable program code configured for calculating author accruals from reviewers as the sum of the points, over all reviews of knowledge assets authored by the member in the community or any of its sub-communities.
computer readable program code configured for calculating author accruals from members as the sum of the points, over all ratings of knowledge assets authored by the member in the community or any of its sub-communities, and
computer readable program code configured for calculating the aggregate rating as the sum of the reviewer accruals, member rating accruals, author accruals from reviewers and author accruals from members.

102. The method as claimed in claim 1, wherein calculating the aggregate rating of a member or a former member in a particular community further comprises the steps of calculating:
reviewer accruals as zero for former members and, for current members, as the sum of the points, over all reviews of knowledge assets done by the member in the community or any of its sub-communities, each such point being conditioned by the recency and frequency of usage of the asset, as well as the current average of the ratings obtained by the asset from members other than the reviewer in the community,
member rating accruals as zero for former members and, for current members, as the sum of the points, over all ratings of knowledge assets in the community or any of its sub-communities done by the member, each such point being conditioned by the recency and frequency of usage of the asset, as well as the current average of the ratings obtained by the asset from members other than the reviewer in the community,
author accruals from reviewers as the sum of the points, over all reviews of knowledge assets authored by the member in the community or any of its sub-communities, each such point being conditioned by the recency and frequency of usage of the asset, as well as the current average of the ratings obtained by the asset from members other than the reviewer in the community,
author accruals from reviewers as the sum of the points, over all reviews of knowledge assets authored by the member in the community or any of its sub-communities,
author accruals from members as the sum of the points, over all ratings of knowledge assets authored by the member in the community or any of its sub-communities, and the aggregate rating as the sum of the reviewer accruals, member rating accruals, author accruals from reviewers and author accruals from members.
